(19) United States
(12) Patent Application Publication
(10) Pub. No.: US 2020/0020671 A1
(43) Pub. Date: Jan. 16, 2020

(54) SINGLE-PIECE MULTI-FREQUENCY INFRARED LIGHT-EMITTING-DIODE (LED) AND MULTI- FREQUENCY HIGH-PRECISION OBJECT RECOGNITION SYSTEM FORMED BY USING THE SAME

(71) Applicants: KUAN-YU LU, Taipei City (TW); WEI-HSIN HUANG, Taipei City (TW); WEI-HUNG CHANG, Taipei City (TW); CHUN-SHING CHU, Taipei City (TW)

(72) Inventors: KUAN-YU LU, Taipei City (TW); WEI-HSIN HUANG, Taipei City (TW); WEI-HUNG CHANG, Taipei City (TW); CHUN-SHING CHU, Taipei City (TW)

(21) Appl. No.: 16/031,508

(22) Filed: Jul. 10, 2018

(51) Int. Cl. H01L 25/075; G06K 9/00; H05B 33/08; G06F 21/32; H01L 33/62

(52) U.S. Cl. CPC H01L 25/0753; G06K 9/00288; G06K 9/00604; H01L 33/62; H05B 33/0806; G06F 21/32; G06K 9/00255

(57) ABSTRACT

A single-piece multi-frequency infrared light-emitting-diode (LED) and a multi-frequency high-precision object recognition system formed by using the same. The LED mentioned is formed by a first infrared light-emitting-die and a second infrared light-emitting-die space apart, having two different wavelengths with their ranges between 850 nm and 1050 nm, to serve as light source for the multi-frequency high-precision object recognition system, to obtain a 3-dimension stereoscopic relief image speedily. In addition, the system is less liable to be affected by the variations of ambient lights, so that the recognition precision for the entire object can be raised effectively. The single-piece multi-frequency infrared light-emitting-diode (LED) can be used extensively in security monitoring, industrial monitoring, human face recognition, image recognition for door opening of a vehicle.

### BACKGROUND OF THE INVENTION

### Field of the Invention

The present invention relates to an image recognition auxiliary illumination technology, and in particular to a single-piece multi-frequency infrared light-emitting-diode (LED) and a multi-frequency high-precision object recognition system formed by using the same.

### The Prior Arts

In general, light-emitting-diode (LED) is used to convert electricity directly into light, and having the advantages of compact size, low power consumption, long service life, non-toxic, and environment protection. Therefore, LED can be used extensively in various applications, such as pilot light, billboard, backlight of liquid crystal display (LCD), and ordinary illumination. Usually, light-emitting-diode (LED) can be classified into visible light LED (wavelength 450 nm to 680 nm) and invisible light LED (wavelength 850 nm to 1550 nm). In the early stage, the LEDs utilized are mostly single-color LEDs.

Along with the rapid progress and development of science and technology, presently, for the visible light LED, various light emitting dies can be packaged and integrated to form a single-piece multi-color LED. The color combination can be achieved through switching of conduction, to fulfill the actual illumination requirements of various applications.

With regards to the invisible light infrared LED (IR LED), it may have various different applications depending on wavelength of light it emits, as explained as follows:

For wavelength of 940 nm: suitable to use for remote controller, such as a remote controller for a household electric appliance.

For wavelength of 808 nm: suitable to use for medical instruments, space light communication, and infrared illumination.

For wavelength of 830 nm: suitable to use for an automatic card system on super highway. In application, the effect of a little red light is better than that of using LED of wavelength 850 nm.

For wavelength of 850 nm: suitable to use for video monitoring, big building intercom, and anti-burglar alarm.

For wavelength of 870 nm: suitable to use for supermarket, camera at crossroad.

Though the invisible light infrared LED has found increasing applications in various fields, yet from its early stage utilized in remote controller and monitor, to the present stage of utilized in the intelligent handset and touch-control panel, its structure does not show marked variations for several decades; while in manufacturing, it still maintains as a single piece LED producing invisible light of single frequency.

The reason for this can be attributed to an important fact that, for a long time, the invisible light infrared LED is used as light source for the remote controller or image monitor. As such, in application, it has to work in cooperation with infrared sensor receiver or image sensor. Thus, the design requirement is that, the related transmission frequency and the receiving frequency must be chosen correctly; otherwise, the subsequent receiving effects could be adversely affected, or it may even not able to perform the normal functions.

In designing the system, the actual requirements of light emission, light reflection, light receiving, pairing-up of devices involved must be taken into consideration. Though in more advanced design, the infrared LED and the infrared sensor receiver can be integrated into as a single piece, to reduce its size and save the space occupied, yet the invisible light infrared LED utilized in this structure is only able to emit light of a single frequency.

In conclusion, due to the technical limitations and bottlenecks, the present technology is only able to produce a single-piece, single-frequency LED capable of emitting invisible lights. In case despite the technology difficulties involved, a plurality of infrared dies are put together to form a single-piece multi-frequency infrared LED. For example, two infrared dies of different wavelengths of 850 nm and 940 nm are put together to form a single-piece double-frequency infrared light-emitting-diode (LED). In this case, the manufacturing process tends to become tedious and cumbersome, while its cost is high. In particular, when the single-piece double-frequency infrared light-emitting-diode (LED) is put on an electric-circuit-board, once the transmitting and receiving wavelengths of an infrared die are chosen and set to be 850 nm (or 940 nm), the other infrared dies of 940 nm (or 850 nm) are lying idle and is wasted.

Therefore, the design and performance of a conventional infrared light-emitting-diode (LED) are not quite satisfactory, and it leaves much room for improvements.

### SUMMARY OF THE INVENTION

In view of the problems and drawbacks mentioned above, the present invention provides a single-piece multi-frequency infrared light-emitting-diode (LED), to overcome the shortcomings of the Prior Art, to achieve the requirements of precision, low cost, and miniaturization, for image recognition.

The present invention provides a single-piece multi-frequency infrared light-emitting-diode (LED) comprising: a carrier; an electrical circuit board, enclosed by the carrier; a plurality of light-emitting-diodes (LEDs), disposed on the electric circuit board, and are spaced apart from each other; a plurality of metal pins, disposed corresponding to and are connected electrically with the plurality of light-emitting-diodes (LEDs) respectively, and are extended outside the carrier in protrusion; and a light emitting port, located on an upper portion of the carrier, and corresponds to the plurality of light-emitting-diodes (LEDs), and it is characterized as follows.

The plurality of light-emitting-diodes (LEDs) on the electrical circuit board all emit infrared lights, and the plurality of light-emitting-diodes (LEDs) each includes a first infrared light-emitting-die and a second infrared light-emitting-die, and the lights emitted are both between wavelength 850 nm and 1050 nm and are spaced apart.

In addition, the present invention further provides a multi-frequency high-precision object recognition system, comprising: at least a multi-frequency light-emitted-unit, a multi-frequency image sensor unit, and an image calculation processing unit. Wherein the multi-frequency light-emitted-unit emits lights of different wavelengths onto an object-to-be-tested, the multi-frequency image sensor unit senses and fetches images of the lights of different wavelengths reflected by the object-to-be-tested, and transmits the images to the image calculation processing unit, and it is characterized as follows.

The at least a multi-frequency light-emitted-unit is formed by a single-piece multi-frequency infrared light-emitting-diode (LED), and lights emitted includes at least two infrared lights, having their wavelengths each between 850 nm and 1050 nm and spaced apart.

The multi-frequency image sensor unit senses and fetches at least two reflected infrared lights of narrow range image signal, having their wavelengths between 850 nm and 1050 nm and are spaced apart, and their wavelength widths between 10 nm and 60 nm.

The image calculation processing unit is adapted to dispose a single-piece planar image in its X axis and its Y axis, the lights of different wavelengths in a Z axis indicate image depth, wherein sample wavelength in the Z axis includes at least two infrared narrow range image signals having their wavelengths between 850 nm and 1050 nm and are spaced apart, and corresponding to that of the multi-frequency image sensor unit, and their wavelength widths are between 10 nm and 60 nm, then calculate to obtain a plurality of single-piece planar images in the X axis and the Y axis as sampled by different wavelength widths in the Z axis, superimpose the plurality of single-piece planar images to form a 3-dimension stereoscopic relief image for precise comparison and recognition.

Due to the much improved recognition effect of the multi-frequency high-precision object recognition system over the conventional technology, it is indeed a breakthrough for the application of the infrared LED. In the early stage of developing the present invention, two single-piece infrared LEDs of different wavelengths 850 nm and 940 nm are utilized, However, since in this approach, the light emitting angle could affect the clearness of the image produced by the subsequent light reflections and receiving. So, the image thus obtained has to go through repeated corrections and adjusting, thus it is rather tedious and time consuming. Yet, the assembled device has to occupy the space of two infrared LEDs. Thus, this approach is not able to meet the high-tech image recognition requirements of precision, low cost, and miniaturization.

Therefore, the present invention adopts a new approach to produce a single-piece multi-frequency infrared light-emitting-diode (LED), to overcome the problems mentioned above. As such, the assembly and production of the multi-frequency high-precision object recognition system is able to meet the requirement of stability, fast speed, precision, low cost, and miniaturization. For this reason, the present invention can be utilized extensively in the various applications of security monitoring, industrial monitoring, face recognition, vehicle door open through image recognition. In particular, when the recognition system is used in an intelligent mobile device, it requires less components to function, to save cost and space significantly. In addition, in application, it is able to fetch 3-dimension stereoscopic relief images precisely at high speed, without being affected by the variations of the ambient lights. Therefore, the major advantage of the present invention is that, it is able to raise the precision of human face recognition.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detail descriptions.

### BRIEF DESCRIPTION OF THE DRAWINGS

The related drawings in connection with the detailed descriptions of the present invention to be made later are described briefly as follows, in which:

FIG. 1 is a perspective view of a single-piece multi-frequency infrared light-emitting-diode (LED) according to the present invention;

FIG. 2A is a top view of a single-piece multi-frequency infrared light-emitting-diode (LED) according to the present invention;

FIG. 2B is an equivalent circuit diagram of a single-piece multi-frequency infrared light-emitting-diode (LED) according to the present invention;

FIG. 2C is a circuit layout of a single-piece multi-frequency infrared light-emitting-diode (LED) according to the present invention;

FIG. 3 is a block diagram of a multi-frequency high-precision object recognition system according to the present invention;

FIG. 4 is a schematic diagram of a 3-dimension stereoscopic relief images produced by a recognition system according to the present invention;

FIG. 5 is a schematic diagram of a single-piece multi-frequency image sensor according to the present invention;

FIG. 6 is a spectrum diagram of image signals received by a single-piece multi-frequency image sensor according to the present invention;

FIG. 7 is a schematic diagram of a recognition system utilized in an intelligent handset according to the present invention;

FIG. 8 is a schematic diagram of an Apple iPhone X equipped to perform human face recognition according to the Prior Art; and

FIG. 9 is another spectrum diagram of image signals received by a single-piece multi-frequency image sensor according to the present invention.

### DETAILED DESCRIPTION OF THE PREFERRED EMBODIMENT

The purpose, construction, features, functions and advantages of the present invention can be appreciated and understood more thoroughly through the following detailed descriptions with reference to the attached drawings.

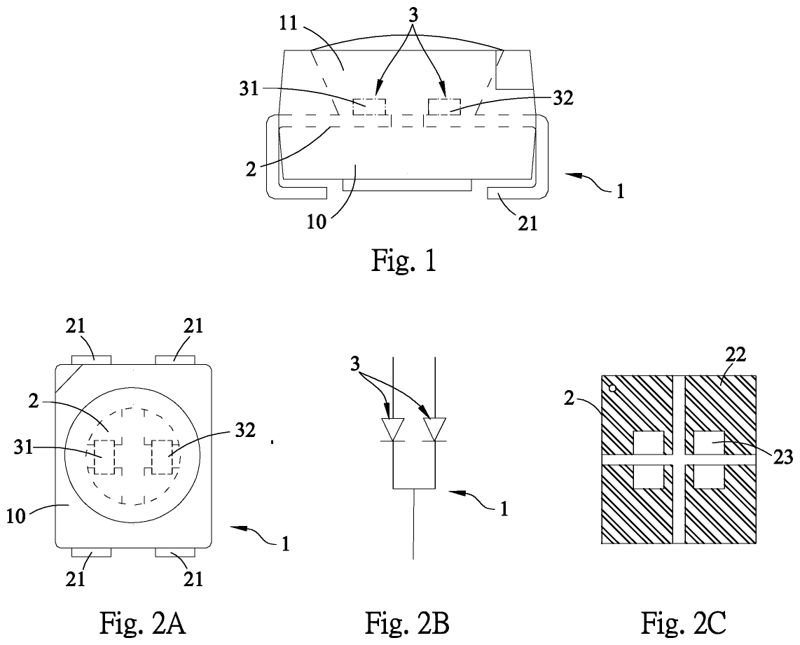

Refer to FIGS. 1 to 2C respectively for a perspective view of a single-piece multi-frequency infrared light-emitting-diode (LED) according to the present invention; a top view of a single-piece multi-frequency infrared light-emitting-diode (LED) according to the present invention; an equivalent circuit diagram of a single-piece multi-frequency infrared light-emitting-diode (LED) according to the present invention; and a circuit layout of a single-piece multi-frequency infrared light-emitting-diode (LED) according to the present invention.

As shown in FIGS. 1 to 2C, the present invention provides a single-piece multi-frequency infrared light-emitting-diode (LED) 1, comprising: a carrier 10; an electrical circuit board 2, enclosed by the carrier 10; a plurality of light-emitting-diodes (LEDs) 3, disposed on the electric circuit board 2, and are spaced apart from each other; a plurality of metal pins 21, disposed corresponding to and connected electrically with the plurality of light-emitting-diodes (LEDs) 3 respectively, and are extended outside the carrier 10 in protrusion; and a light emitting port 11, located on an upper portion of the carrier 10, and corresponds to the plurality of light-emitting-diodes (LEDs) 3, and it is characterized as follows.

The plurality of light-emitting-diodes (LEDs) 3 on the electrical circuit board 2 all emit infrared light, and the plurality of light-emitting-diodes (LEDs) 3 each includes a first infrared light-emitting-die 31 and a second infrared light-emitting-die 32, and the lights emitted are both between wavelength 850 nm and 1050 nm and are spaced apart.

The light emitting port 11 is of a cone shape, lights emitted by the first infrared light-emitting-die 31 and the second infrared light-emitting-die 32 are of wavelengths selected from two of the following: 850 nm, 940 nm, and 1050 nm.

A total of two infrared light-emitting-dies 31, 32 are provided on the electrical circuit board 2. The electrical circuit board 2 is cross-divided into four copper separation regions 22, and two die fixing parts 23 are disposed respectively on the two copper adjacent separation regions 22 adjacent to each other. The first infrared light-emitting-die 31 emits light of wavelength 850 nm, the second infrared light-emitting-die 32 emits light of wavelength 940 nm.

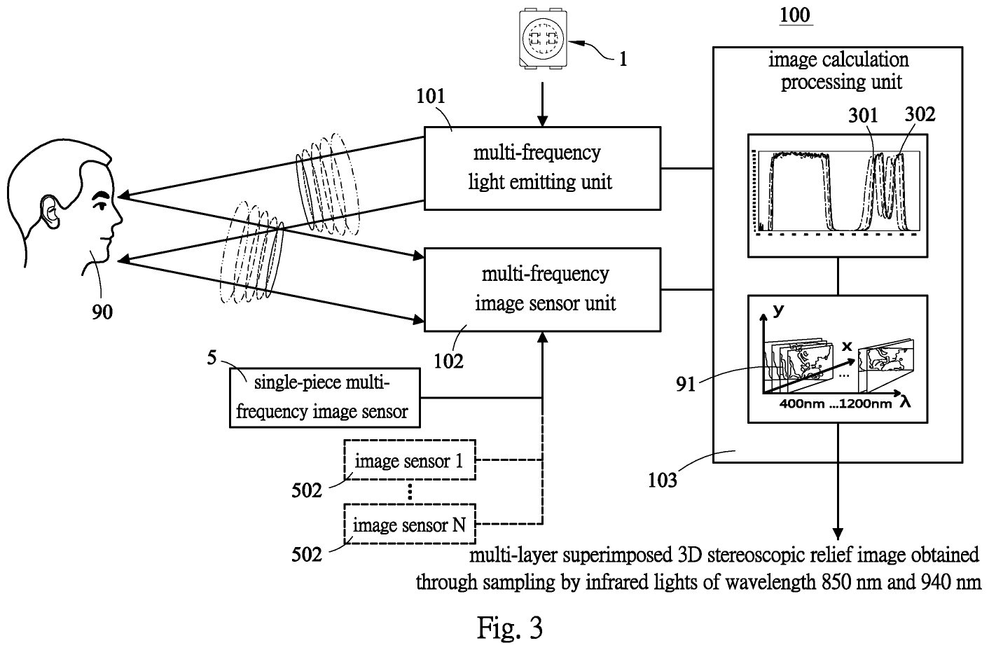

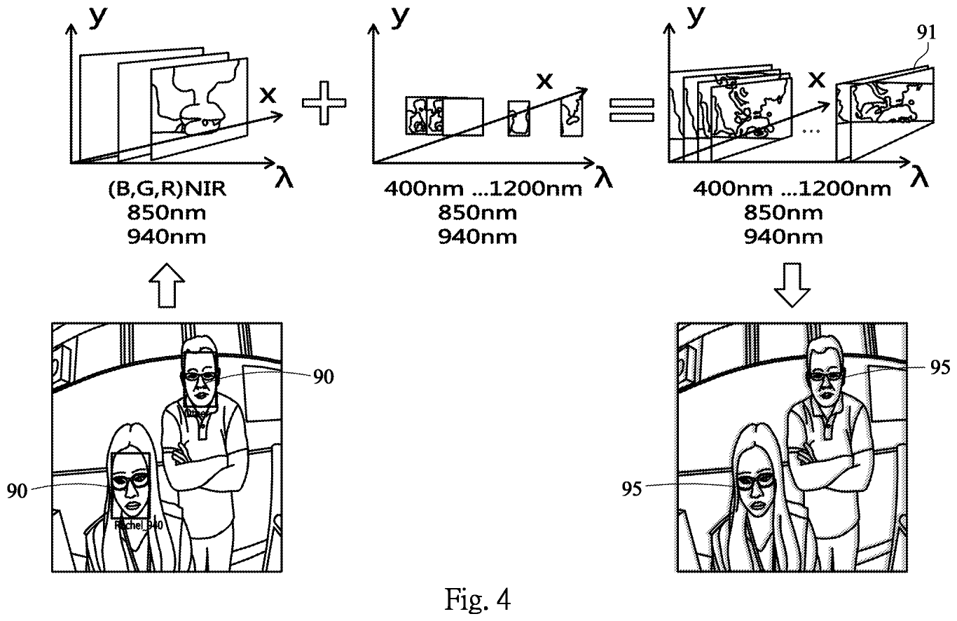

Refer to FIGS. 3 and 4 for a block diagram of a multi-frequency high-precision object recognition system according to the present invention; and a schematic diagram of a 3-dimension stereoscopic relief images produced by a recognition system according to the present invention. As shown in FIGS. 3 and 4, the present invention further provides a multi-frequency high-precision object recognition system 100, comprising: at least a multi-frequency light-emitted-unit 101 a multi-frequency image sensor unit 102, and an image calculation processing unit 103. Wherein the multi-frequency light-emitted-unit 101 emits lights of different wavelengths onto an object-to-be-tested 90, the multi-frequency image sensor unit 102 senses and fetches images of the lights of different wavelengths reflected by the object-to-be-tested 90, and transmits the images to the image calculation processing unit 103, and it is characterized as follows.

The at least a multi-frequency light-emitted-unit 101 is formed by a single-piece multi-frequency infrared light-emitting-diode (LED) 1, and the lights emitted includes at least two infrared lights, having their wavelengths each between 850 nm and 1050 nm and spaced apart. The light emitted by the first infrared light-emitting-die 31 is of wavelength 850 nm, and the light emitted by the second infrared light-emitting-die 32 is of wavelength 940 nm.

The multi-frequency image sensor unit 102 senses and fetches at least two reflected infrared lights of narrow range image signals 301 and 302, having their wavelengths between 850 nm and 940 nm and are spaced apart, and having their wavelength widths between 10 nm and 60 nm.

The image calculation processing unit 103 is adapted to dispose a single-piece planar image 91 in its X axis and its Y axis, the lights of different wavelengths in a Z axis indicate an image depth. Wherein, sample wavelength in the Z axis includes at least two infrared narrow range image signals 301, 302 having their wavelengths between 850 nm and 940 nm and spaced apart and corresponding to that of the multi-frequency image sensor unit 102, and their wavelength widths are between 10 nm and 60 nm. Then, calculate to obtain a plurality of single-piece planar images 91 in the X axis and the Y axis as sampled by different wavelength widths in the Z axis. Then, superimpose the plurality of single-piece planar images 91 into a 3-dimension stereoscopic relief image 95 for precise comparison and recognition.

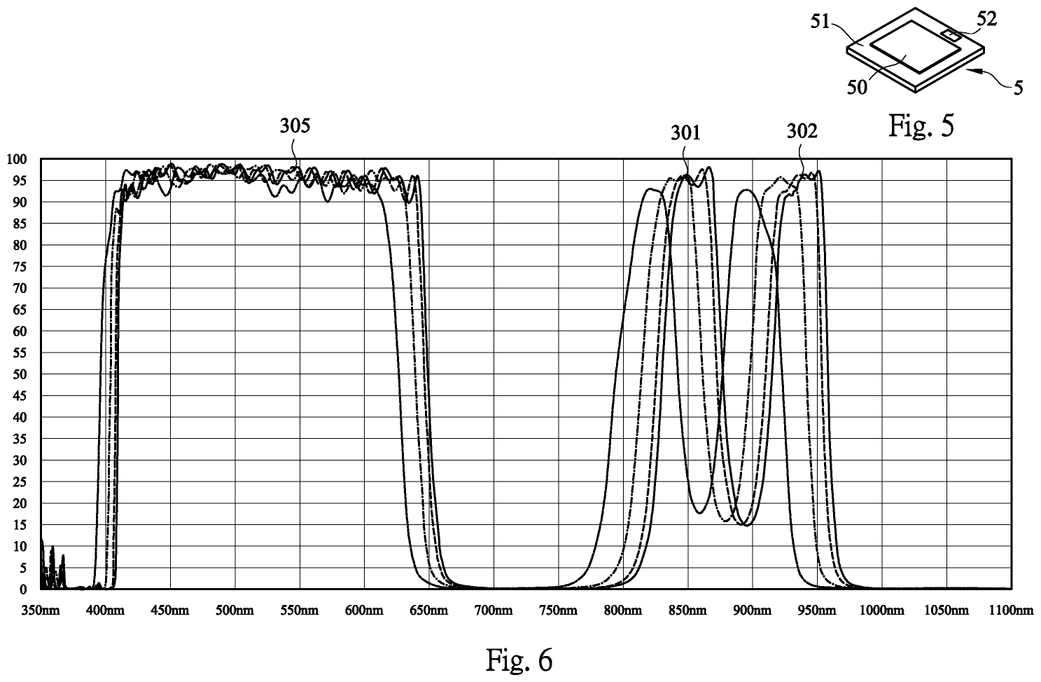

Then, refer to FIGS. 5 and 6 for a schematic diagram of a single-piece multi-frequency image sensor according to the present invention; and a spectrum diagram of image signals received by a single-piece multi-frequency image sensor according to the present invention. As shown in FIGS. 3 to 6, the multi-frequency image sensor unit 102 is formed by a plurality of image sensors 502 of different frequencies or a single-piece multi-frequency image sensor 5. The single-piece multi-frequency image sensor 5 includes: a light sensing pixel array 50, a packaging circuit 51, and an image enhancing processor unit 52. The packaging circuit 51 is connected to the light sensing pixel array 50, to drive the light sensing pixel array 50 to capture outside light and convert it into a combined image signal for output, the light sensing pixel array 50 captures RGB full color visible light, and IR infrared invisible light to perform photoelectric conversion. The image enhancing processor unit 52 is embedded in the packaging circuit 51, to control and regulate image captured by the light sensing pixel array 50. The image includes: a full color RGB visible light wide range image signal 305 having its wavelength range between 400 nm and 700 nm, and at least two infrared invisible light narrow range image signals 301, 302 and having their wavelength ranges between 850 nm and 940 nm, a wavelength width for each of the two infrared invisible light narrow range image signals 301, 302 is between 10 nm and 60 nm. The full color RGB visible light wide range image signal 305 and the two infrared invisible light narrow range image signals 301, 302 are superimposed and combined, to produce a clear output image having a stereoscopic sense of a front layer and a back layer.

In the present invention, in order to achieve better recognition, the image signal formed by superimposing the wide range image signal 305 and at least two narrow range image signals 301, 302 is used, to realize clearness of layers and to give a sense of depth and layer. And this can be used to calculate precisely the 3-dimension characteristics of the object-to-be-tested 90, such as distance of depth, hand gesture, getting around an obstacle, etc. That is quite important for 3-dimension image depth and distance measurement applications, such as Virtual Reality/Augmented Reality (VR/AR), drone, people/things counting. Further, it is capable of performing depth measurements for object-to-be-tested 90 and its surroundings. As such, the technology of the present invention can also be used in the fields of Artificial Intelligence (AI), and Computer Vision. For example, the recognition system 100 can be installed in a vehicle (not shown), and is used for face recognition door opening for an automobile, or fatigue detection for a motor cyclist, but the present invention is not limited to this.

In the descriptions above, the object-to-be-tested 90 can be a human face, and that is used quite often in face recognition turn-on of a mobile device, or face recognition turn-on of an automatic payment device. The multi-frequency high-precision object recognition system of the present invention can be put on an intelligent mobile device, such as an intelligent handset or a tablet, etc., yet the present invention is not limited to this. The recognition system 100 may also be put on a desk top computer or a notebook computer.

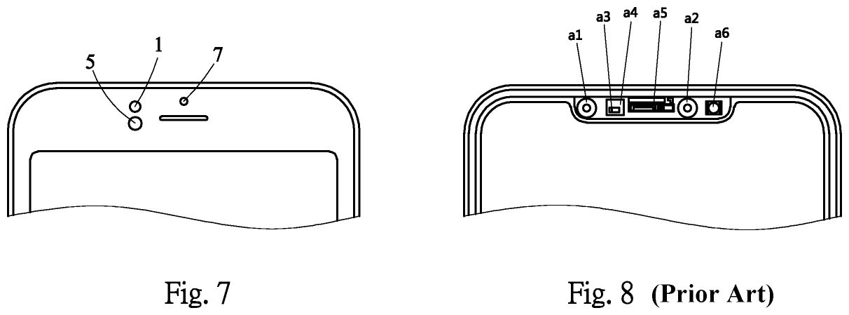

Refer to FIG. 7 for a schematic diagram of a recognition system utilized in an intelligent handset according to the present invention. As shown in FIG. 7, in this case, all the equipment required is a single-piece multi-frequency infrared light-emitting-diode (LED) 1, a single-piece multi-frequency infrared image sensor 5, and an ambient light sensor 7. For the case that the intelligent handset is an iPhone X handset of Apple, the overall structure and design is able to achieve cost and space saving, while raising the recognition precision significantly. Further, refer to FIG. 8 for a schematic diagram of an Apple iPhone X equipped to perform human face recognition according to the Prior Art. As shown in FIG. 8, in this respect, it basically requires the following devices to achieve face recognition: an infrared lens a1, a seven-million-pixel lens a2, a flood illuminator a3, a proximity sensor a4, an ambient light sensor a5, and a dot projector a6. In addition, high precision assembly is required to achieve face recognition. The disadvantages of this design are that it requires to use quite a lot of devices to induce high cost, while it occupies a rather large space. Compared with the Prior Art, it is evident that, the present invention does have a competitive edge in the market.

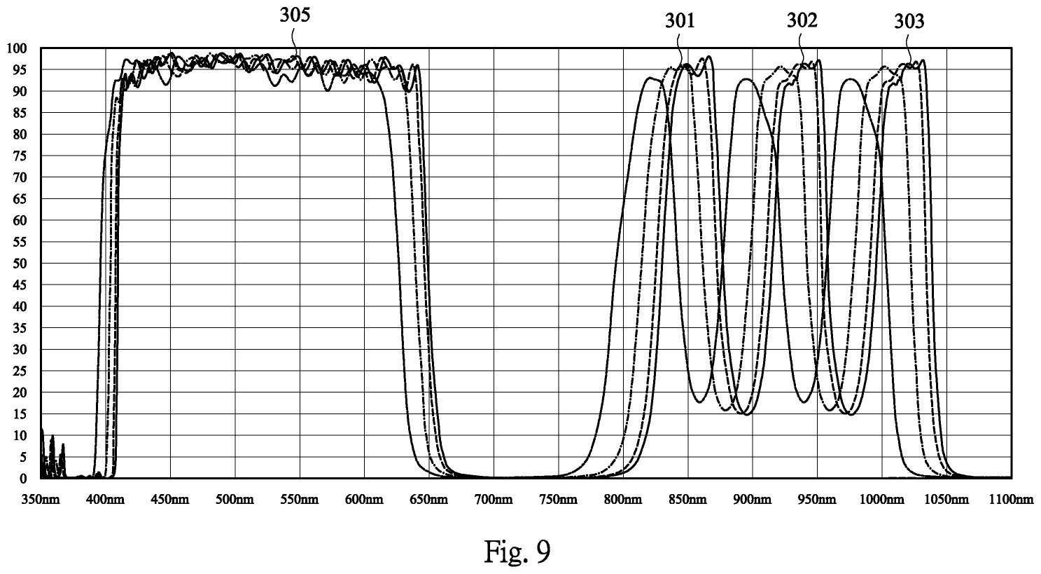

Moreover, as shown in FIG. 4, in the present invention, the image enhancing processor unit 52 can be realized through a software or a firmware, to facilitate revising or increasing the amount of the narrow range image signals captured, or adjusting the transmittance of the image signal to a range between 30% and 95%. As shown in FIGS. 1 and 9, in case it is required, a third infrared light-emitting-die (not shown) can be put on the electric circuit board 2, having its light emitting wavelength of 1050 nm. As such, in fetching image signals, a narrow range image signal 303 of wavelength of 1050 nm can be added. Therefore, the image signals obtained through superimposing three narrow range image signals 301, 302, 303 having wavelengths of 850 nm, 940 nm, and 1050 nm respectively, the recognition of layers and depths can be more evident, to raise the stereoscopic sense and clearness of the overall image effectively.

In the descriptions above, only one infrared light-emitting-die is added, however, the present invention is not limited to this. In fact, the amount of infrared light-emitting-die added can be classified into various grades corresponding to different recognition precisions. As such, it can be customized to use extensively in various applications, such as security monitoring, industrial monitoring, face recognition, webcam, drone, robot, and vehicle backup auxiliary image fetching.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A single-piece multi-frequency infrared light-emitting-diode (LED), comprising:
a carrier;
an electrical circuit board, enclosed by the carrier;
a plurality of light-emitting-diodes (LEDs), disposed on the electric circuit board, and are spaced apart from each other;
a plurality of metal pins, disposed corresponding to and connected electrically with the plurality of light-emitting-diodes (LEDs), and are extended outside the carrier in protrusion; and
a light emitting port, located on an upper portion of the carrier, and corresponds to the plurality of light-emitting-diodes (LEDs), and it is characterized in that, the plurality of light-emitting-diodes (LEDs) on the electrical circuit board all emit infrared lights, and the plurality of light-emitting-diodes (LEDs) each includes a first infrared light-emitting-die and a second infrared light-emitting-die, and the lights emitted are both between wavelength 850 nm and 1050 nm and spaced apart.

2. The single-piece multi-frequency infrared light-emitting-diode (LED) as claimed in claim 1, wherein light emitting port is of a cone shape, lights emitted by the first infrared light-emitting-die and the second infrared light-emitting-die are of wavelengths selected from two of the following: 850 nm, 940 nm, and 1050 nm.

3. The single-piece multi-frequency infrared light-emitting-diode (LED) as claimed in claim 1, wherein a total of two infrared light-emitting-dies are provided on the electrical circuit board 2, the electrical circuit board 2 is cross divided into four copper separation regions, and two die fixing parts are disposed respectively on two copper adjacent separation regions adjacent to each other.

4. The single-piece multi-frequency infrared light-emitting-diode (LED) as claimed in claim 1, wherein the first infrared light-emitting-die emits light of wavelength 850 nm, the second infrared light-emitting-die emits light of wavelength 940 nm, and a third infrared light-emitting-die disposed on the electrical circuit board, and it emits light of wavelength 1050 nm.

5. A multi-frequency high-precision object recognition system, comprising:
at least a multi-frequency light-emitted-unit, a multi-frequency image sensor unit, and an image calculation processing unit, wherein the multi-frequency light-emitted-unit emits lights of different wavelengths onto an object-to-be-tested, the multi-frequency image sensor unit senses and fetches images of the lights of different wavelengths reflected by the object-to-be-tested, and transmits the images to the image calculation processing unit, and it is characterized in that:
the at least a multi-frequency light-emitted-unit is formed by a single-piece multi-frequency infrared light-emitting-diode (LED), and lights emitted includes at least two infrared lights, having their wavelengths each between 850 nm and 1050 nm and spaced apart;
the multi-frequency image sensor unit senses and fetches at least two reflected infrared lights of a narrow range image signal, having their wavelengths between 850 nm and 1050 nm and are spaced apart, and their wavelength widths between 10 nm and 60 nm; and
the image calculation processing unit is adapted to dispose a single-piece planar image in its X axis and its Y axis, the lights of different wavelengths in a Z axis indicate an image depth, wherein sample wavelength in the Z axis includes at least two infrared narrow range image signals having their wavelengths between 850 nm and 1050 nm and spaced apart and corresponding to that of the multi-frequency image sensor unit, and their wavelength widths are between 10 nm and 60 nm, then calculate to obtain a plurality of single-piece planar images in the X axis and the Y axis as sampled by different wavelength widths in the Z axis, superimpose the plurality of single-piece planar images into a 3-dimension stereoscopic relief image for precise comparison and recognition.

6. The multi-frequency high-precision object recognition system as claimed in claim 5, wherein the multi-frequency image sensor unit is formed by a plurality of image sensors of different frequencies or a single-piece multi-frequency image sensor, the single-piece multi-frequency image sensor includes:
a light sensing pixel array;
a packaging circuit, connected to the light sensing pixel array, to drive the light sensing pixel array to capture outside light and convert it into a combined image signal for output, the light sensing pixel array captures RGB full color visible light, and IR infrared invisible light to perform photoelectric conversion; and
an image enhancing processor unit, embedded in the packaging circuit, to control and regulate image captured by the light sensing pixel array, the image includes: a full color RGB visible light wide range image signal having its wavelength range between 400 nm and 700 nm, and at least two infrared invisible light narrow range image signals and having their wavelength ranges between 850 nm and 940 nm, a wavelength width for each of the two infrared invisible light narrow range image signals is between 10 nm and 60 nm, the full color RGB visible light wide range image signal and the two infrared invisible light narrow range image signals are superimposed and combined, to produce a clear output image having a stereoscopic sense of a front layer and a back layer.

7. The multi-frequency high-precision object recognition system as claimed in claim 5, wherein the object-to-be-tested is a human face.

8. The multi-frequency high-precision object recognition system as claimed in claim 5, wherein the object-to-be-tested is a human face or a human eye iris.

9. The multi-frequency high-precision object recognition system as claimed in claim 5, wherein the multi-frequency high-precision object recognition system is installed on an intelligent mobile device.

10. The multi-frequency high-precision object recognition system as claimed in claim 5, wherein the multi-frequency high-precision object recognition system is installed on a vehicle.
